(19) United States
(12) Patent Application Publication
(10) Pub. No.: US 2026/0161751 A1
(43) Pub. Date: Jun. 11, 2026

(54) INFORMATION PROCESSING APPARATUS, CONTROL METHOD FOR INFORMATION PROCESSING APPARATUS, AND STORAGE MEDIUM

(71) Applicant: CANON KABUSHIKI KAISHA, Tokyo (JP)

(72) Inventor: TOMOKI TAMINATO, Kanagawa (JP)

(21) Appl. No.: 19/401,146

(22) Filed: Nov. 25, 2025

(30) Foreign Application Priority Data
Dec. 5, 2024 (JP) 2024-212469

(51) Int. Cl. G06F 21/12; G06F 21/60; H04W 4/029

(52) U.S. Cl. CPC G06F 21/121; G06F 21/602; H04W 4/029

(57) ABSTRACT

An information processing apparatus includes a setting unit that sets a usage condition including spatial information about a position range of a user terminal that performs processing using artificial intelligence, a provision unit that provides a model of the artificial intelligence to the user terminal, an acquisition unit that acquires position information about the user terminal to which the artificial intelligence model is provided, and a restriction unit that restricts use of the artificial intelligence model provided to the user terminal based on the set usage condition and the acquired position information about the user terminal.

### BACKGROUND

### Field of the Technology

The present disclosure relates to an information processing apparatus, a method for controlling the information processing apparatus, and a storage medium.

### Description of the Related Art

In recent years, there have been increased cases of use of artificial intelligence models generated using machine learning techniques in various fields. For example, artificial intelligence is used to control imaging in imaging fields, such as a camera or the like. With widespread use of machine learning techniques, artificial intelligence models are shared with a limited number of companies and organizations, and also with many general users. As a result, there are an increasing number of systems that enable general users to use artificial intelligence models.

In such systems that use artificial intelligence models, there may be cases where a third party uses an artificial intelligence model beyond the scope of the license agreement or makes modifications including training of the artificial intelligence model. In these cases, the provider and the user of the artificial intelligence model may be adversely affected, causing a growing demand for a mechanism for appropriately managing an artificial intelligence model.

International Publication No. 2018/061700 describes an information processing apparatus that adds information about a period during which an artificial intelligence model is available for use to license information about the artificial intelligence model and determines whether to execute processing using the artificial intelligence based on the period information. Japanese Patent Laid-Open No. 2020-204833 describes an information processing apparatus that monitors artificial intelligence based on a state of connection to a network to determine whether to execute artificial intelligence processing.

In the techniques described in International Publication No. 2018/061700 and Japanese Patent Laid-Open No. 2020-204833, an artificial intelligence model may be inappropriately used even in a state where the artificial intelligence model is valid within the available period or the information processing apparatus is connected to a network. Thus, there is an issue that it is difficult to appropriately manage an artificial intelligence model in a case where the artificial intelligence model is inappropriately used as described above.

### SUMMARY

The present disclosure is directed to enabling more appropriate management of artificial intelligence models in view of the above-described issue.

According to an aspect of the present disclosure, an information processing apparatus includes a setting unit configured to set a usage condition including spatial information about a position range of a user terminal that performs processing using artificial intelligence, a provision unit configured to provide a model of the artificial intelligence to the user terminal, an acquisition unit configured to acquire position information about the user terminal to which the artificial intelligence model is provided, and a restriction unit configured to restrict use of the artificial intelligence model provided to the user terminal based on the set usage condition and the acquired position information about the user terminal.

Features of the present disclosure will become apparent from the following description of embodiments with reference to the attached drawings. The following description of embodiments is described by way of example.

### BRIEF DESCRIPTION OF THE DRAWINGS

FIG. 1 is a block diagram illustrating an example of a hardware configuration of an information processing apparatus.

FIG. 2 is a block diagram illustrating an example of a functional configuration of the information processing apparatus according to a first embodiment.

FIG. 3 illustrates an example of a user interface (UI) for setting a range where an artificial intelligence model is available for use.

FIG. 4 is a flowchart illustrating an example of a processing procedure for setting the artificial intelligence model to a stopped state or an executable state.

FIG. 5 illustrates an example of a system configuration for managing the artificial intelligence model shared between two user terminals.

FIG. 6 illustrates an example of a system configuration for managing an artificial intelligence model shared between three user terminals.

FIG. 7 illustrates an example of a positional relationship between the three user terminals.

FIG. 8 is a block diagram illustrating an example of a functional configuration of an information processing apparatus according to a third embodiment.

FIG. 9 is a flowchart illustrating an example of a processing procedure for training an artificial intelligence model.

### DESCRIPTION OF THE EMBODIMENTS

Embodiments of the present disclosure will now be described with reference to the attached drawings. The present disclosure is not limited to the described embodiments, and various other implementations that do not depart from the gist of the present disclosure are also encompassed within the present disclosure. Each embodiment described in the following is merely an example of the present disclosure, and can be combined with each other as appropriate.

### First Embodiment

According to a first embodiment, for description purposes, an example will be described where a user owns a camera that can run artificial intelligence, and a system that manages artificial intelligence suitable for a specific location or a specific space via an information processing apparatus. In the following description, the camera owned by the user is referred to as a user terminal. The user terminal described in the present disclosure is not limited to cameras and can be any device as long as the device can communicate with the information processing apparatus according to the present embodiment. The user terminal can be, for example, a device, such as a smartphone, smart glasses, a smartwatch, a laptop personal computer, or a tablet terminal, while the information processing apparatus according to the present disclosure can be included in the user terminal. As artificial intelligence that can be run in a camera, for example, artificial intelligence is assumed to be specialized for recognizing a certain subject or imaging condition to detect the subject, and thus, the camera controls autofocus, which enables the user to capture a desired scene without missing the moment.

### Hardware Configuration

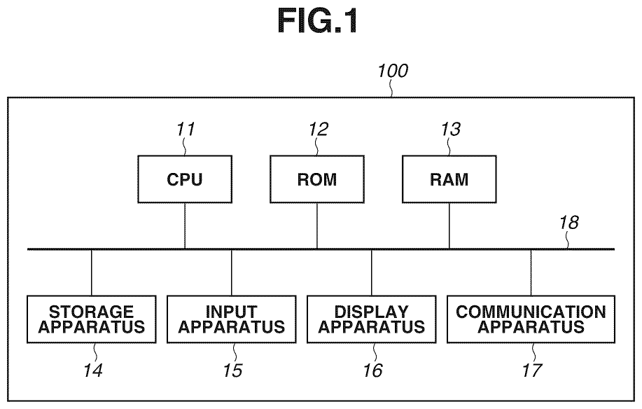

FIG. 1 is a block diagram illustrating an example of a hardware configuration of an information processing apparatus 100 according to the present embodiment. As illustrated in FIG. 1, the information processing apparatus 100 includes a central processing unit (CPU) 11, a read-only memory (ROM) 12, a random-access memory (RAM) 13, a storage apparatus 14, an input apparatus 15, a display apparatus 16, and a communication apparatus 17, where these components are connected to each other via a connection bus 18.

The CPU 11 executes control programs stored in the ROM 12 or the storage apparatus 14 to control the information processing apparatus 100.

The ROM 12, which is a nonvolatile memory, stores control programs and various parameters.

The control programs are executed by the CPU 11 to perform the processing described below.

The RAM 13, which is a volatile memory, temporarily stores image data, control programs, and the execution results.

The storage apparatus 14, which is a rewritable storage apparatus, such as a hard disk or a flash memory, stores various kinds of data used in processing of the present embodiment. For example, the storage apparatus 14 stores input data, control programs, the processing results, and the like. These pieces of information are output to the RAM 13 to be used by the CPU 11 in executing programs.

The input apparatus 15, which serves as an interface external to the information processing apparatus 100, includes a mouse, a keyboard, and a button, each of which receives various operations from the user. The input apparatus 15 can be a touch panel with which the user can input operations.

The display apparatus 16 is a monitor including a liquid crystal display that displays results of processing programs, images, and the like.

The communication apparatus 17 performs wired or wireless communication with another information processing apparatus, a terminal, a communication device, an external storage device, and the like, using a known communication technique. The communication apparatus 17 is provided with one or more devices that determine a position using wireless communication, such as Global Positioning System (GPS), Wi-Fi®, beacons, and radio frequency identification (RFID).

The connection bus 18 connects each configuration in the information processing apparatus 100 to enable mutual data communication between the components.

According to the present embodiment, the CPU 11 executes control programs to perform processing described below, but part or all of the processing can be performed using hardware. As the hardware, a dedicated circuit (an application specific integrated circuit (ASIC)), a processor (a reconfigurable processor and a digital signal processor (DSP)), and the like, can be used. Software in which processing described below is described can be acquired via a network or various storage media to be executed on the information processing apparatus 100 according to the present embodiment.

### Functional Configuration

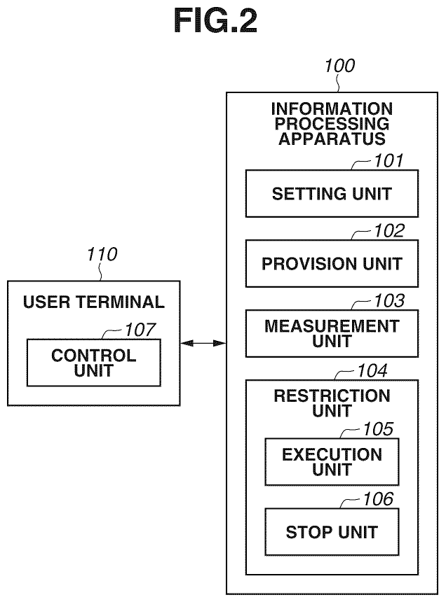

FIG. 2 is a block diagram illustrating an example of a functional configuration of the information processing apparatus 100 according to the present embodiment.

As illustrated in FIG. 2, the information processing apparatus 100 includes a setting unit 101, a provision unit 102, a measurement unit 103, and a restriction unit 104. The information processing apparatus 100 is connected to a user terminal 110 that uses an artificial intelligence model. The user terminal 110 includes a control unit 107.

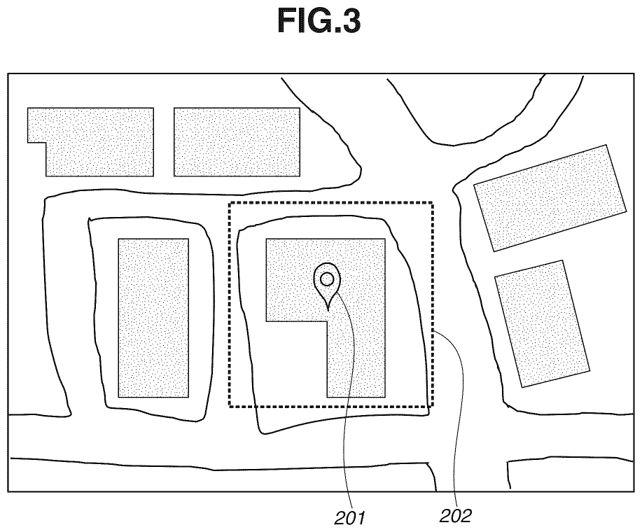

The setting unit 101 sets a range in which the artificial intelligence model to be provided to the user terminal 110 is available for use (spatial information) as a usage condition. In the available range (the spatial information), modification (retraining, additional training, and the like) of the artificial intelligence model can be permitted. Within the range where the model provider can control the artificial intelligence model, the accuracy of the artificial intelligence model can be further increased. It is also possible to prohibit any modifications (retraining, additional training, and the like) of the artificial intelligence model without granting any permission. Prohibiting any modifications (retraining, additional training, and the like) of the artificial intelligence model enables preventing disadvantages that cannot be controlled by the model provider. This can avoid any damage to the reputation of the model provider due to leakage of privacy information from the model or generation of a low-accuracy model. FIG. 3 illustrates an example of a user interface (UI) for setting the range where the artificial intelligence model is available for use using the setting unit 101. An example will now be described of a method for setting the range where the artificial intelligence model is available for use with reference to FIG. 3.

The setting unit 101 causes the display apparatus 16 to display a map using, for example, a map application, which is commercially available or released on a web site, to prompt the user who provides the artificial intelligence model to select the position of an available facility through, for example, a mouse operation. At that time, as illustrated in FIG. 3, the user specifies the position of the facility using a pointer 201 or with a valid range 202. The user specifying the position of the facility in this manner results in setting of the available range of the artificial intelligence model to be provided. The setting unit 101 stores the coordinates of the specified position or the specified range as the spatial information regarding where the artificial intelligence model to be provided is available for use.

According to the present embodiment, a configuration is conceivable that restricts the use of artificial intelligence within a specific spatial range in an indoor facility. In such a configuration, for example, by using a communication device, such as a beacon device or a Wi-Fi® device installed at a specific indoor location to receive spatial information, such as a distance and/or a direction, from a communication position, the setting unit 101 sets the spatial information regarding where the artificial intelligence model is available for use. In this case, the user terminal 110 requires a communication device capable of beacon communication or Wi-Fi® communication. The setting unit 101 may set other usage conditions, such as a period during which artificial intelligence is available and license information, in combination with the spatial information. For a specific processing method regarding such usage conditions, a known technique, for example, a processing method described in International Publication No. 2018/061700 can be used.

The provision unit 102 provides the user terminal 110 with the artificial intelligence model to be provided to the user and the usage conditions including the spatial information set by the setting unit 101. According to the present embodiment, the provision unit 102 first encrypts the artificial intelligence model to provide the encrypted artificial intelligence model to the user terminal 110. Encryption of the artificial intelligence model refers to a state in which a part or all of a parameter group of the model required to run the artificial intelligence are concealed. The provision unit 102 encrypts the artificial intelligence model using, for example, artificial intelligence encryption means of a known technique. The provision unit 102 may provide only a part of the parameter group of the artificial intelligence model to the user terminal 110, and then provide the rest of the parameter group in the available state. By providing the encrypted artificial intelligence model as described above, it is possible to prevent the artificial intelligence model from being used at locations other than the specific location or from being misappropriated. The encrypted artificial intelligence model is stored in the ROM or the storage apparatus, both of which are nonvolatile memories, in the user terminal 110.

The control unit 107 of the user terminal 110 can be configured to restrict access to the artificial intelligence model in a case where the control unit 107 of the user terminal 110 determines that the usage conditions are not satisfied, restricting the use outside the available range. The restriction may enable the artificial intelligence model to be provided without encryption. In a case where the artificial intelligence model is provided to the user terminal 110, the artificial intelligence model can be transmitted to the user terminal 110 using a known communication technique if the user terminal 110 enters a specific range or can be provided to the user terminal 110 in advance via an internet environment or a cloud environment.

Before providing the artificial intelligence model, the provision unit 102 may cause the display apparatus 16 to display a UI to notify the user terminal 110 of information about the performance and the usage conditions of the artificial intelligence model to be provided to the user terminal 110 and about the specifications required for execution of the artificial intelligence model. In addition, the provision unit 102 may be configured to provide the artificial intelligence model to the user terminal 110 in a case where the user terminal 110 determines to accept the provision of the artificial intelligence model. The provision unit 102 may enable the user terminal 110 to select an artificial intelligence model to be used and cause the display apparatus 16 to display a UI to provide the artificial intelligence model together with the usage conditions in response to the request.

The measurement unit 103 acquires current position information about the user terminal 110. The measurement unit 103 transmits to the user terminal 110 a request to acquire the position information using, for example, the GPS and thus, receives the position information from the user terminal 110. The measurement unit 103 acquires the position information about the user terminal 110 at predetermined time intervals to update the current position of the user terminal 110.

When the artificial intelligence model in the user terminal 110 is used indoors, the measurement unit 103 measures an indoor position of the user terminal 110 using a known technique using, for example, beacons or Wi-Fi®. In this case, if the user terminal 110 is outside the specific range, preventing communication, the position of the user terminal 110 cannot be measured. In this case, it can be determined that the user terminal 110 is outside the available range in which the user terminal 110 can use the artificial intelligence model.

The restriction unit 104 determines whether the artificial intelligence model provided by the provision unit 102 can be used in the user terminal 110 based on the position information about the user terminal 110 acquired by the measurement unit 103 and the spatial information set by the setting unit 101. The restriction unit 104 includes an execution unit 105 and a stop unit 106, and when the artificial intelligence model can be used in the user terminal 110, the execution unit 105 makes the artificial intelligence model available for use. When the artificial intelligence model cannot be used in the user terminal 110, the stop unit 106 brings the use of the artificial intelligence model into a stopped state. A processing procedure by the restriction unit 104 will now be described.

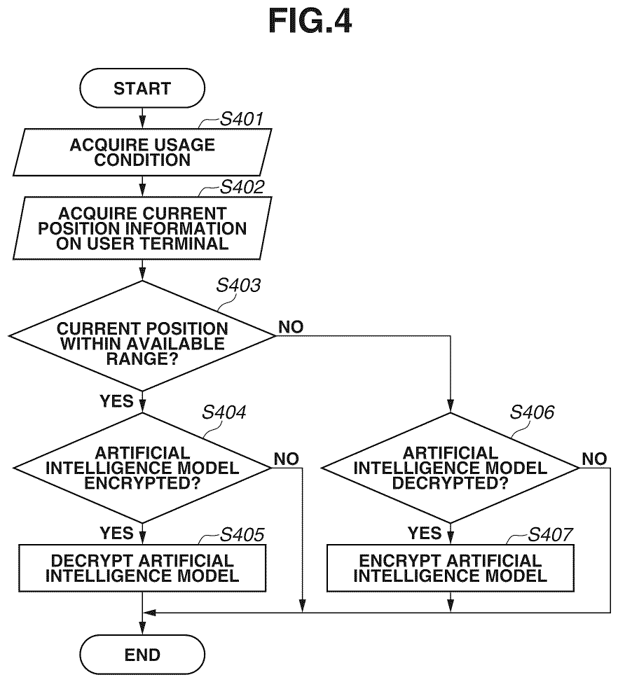

FIG. 4 is a flowchart illustrating an example of a processing procedure of the restriction unit 104 bringing the artificial intelligence model into the stopped state or an executable state. The processing in FIG. 4 is performed each time the measurement unit 103 acquires the position information about the user terminal 110 at predetermined time intervals.

In step S401, the restriction unit 104 acquires information about the usage conditions including the spatial information about the artificial intelligence model set by the setting unit 101 and provided to the user terminal 110.

In step S402, the restriction unit 104 acquires the current position information about the user terminal 110 from the measurement unit 103.

In step S403, the restriction unit 104 determines whether the current position of the user terminal 110 is within the available range of the artificial intelligence model. As a result of the determination, if the current position of the user terminal 110 is within the available range of the artificial intelligence model (YES in step S403), the processing proceeds to step S404. If the user terminal 110 is not within the available range (NO in step S403), the processing proceeds to step S406.

In step S404, the execution unit 105 of the restriction unit 104 determines whether the artificial intelligence model in the user terminal 110 is in an encrypted state. If the artificial intelligence model is not in an encrypted state (NO in step S404), the processing ends without performing update processing. If the artificial intelligence model is in an encrypted state (YES in step S404), the processing proceeds to step S405.

In step S405, the execution unit 105 of the restriction unit 104 performs processing for decrypting the encrypted artificial intelligence model. For example, the restriction unit 104 transmits data used to decrypt the artificial intelligence model to the user terminal 110 so that the user terminal 110 can decrypt the artificial intelligence model. Regarding the decryption method, a known encryption method is used, and by a paired decryption method, the encrypted artificial intelligence model is decrypted. Thus, the decryption method can be any method as long as the method enables the user terminal 110 to decrypt the encrypted artificial intelligence model for use.

In a case where a part of the parameter group of the artificial intelligence model is provided in advance by the provision unit 102, the execution unit 105 provides the rest of the parameter group, enabling the artificial intelligence model to be decrypted.

The parameter group of the artificial intelligence model and the data used for decryption can be temporarily stored in a RAM, in the user terminal 110 without storing in a ROM or a storage apparatus. This enables the artificial intelligence model is made decryptable in the user terminal 110 only when the artificial intelligence model is available for use, which makes it possible to further enhance the effect of preventing the artificial intelligence from being used under a condition other than the usage conditions.

In step S406, the stop unit 106 of the restriction unit 104 determines whether the artificial intelligence model in the user terminal 110 is in a decrypted state. If the artificial intelligence model is not decrypted but encrypted (NO in step S406), the processing ends. If the artificial intelligence model is decrypted (YES in step S406), the processing proceeds to step S407.

In step S407, the stop unit 106 of the restriction unit 104 performs processing for encrypting the parameter group of the artificial intelligence model again. For example, the restriction unit 104 transmits data to be used to encrypt the artificial intelligence model to the user terminal 110, enabling encryption of the artificial intelligence model in the user terminal 110. If the parameter group of the artificial intelligence model and the data to be used for decryption are stored in the RAM in the user terminal 110, those pieces of information are erased from the RAM, and the artificial intelligence model is re-encrypted by being replaced with the encrypted model.

Another processing method by the stop unit 106 includes the stop unit 106 causing the control unit 107 of the user terminal 110 to stop execution of the artificial intelligence or performing control to not output an execution result of the artificial intelligence. The artificial intelligence model may be deleted from the user terminal 110. According to the present embodiment, the user terminal 110 is provided with an encrypted artificial intelligence model in advance, but the encrypted model cannot be used on its own, and the artificial intelligence model cannot be used unless the artificial intelligence model is decrypted. This makes it possible to prevent the use of the artificial intelligence model outside a specific space or a specific location.

In step S407, the stop unit 106 may perform processing for encrypting the parameter group of the artificial intelligence model, and then notify the user terminal 110 that the artificial intelligence model is no longer available. By processing in this manner, the user terminal 110 that receives the notification can immediately recognize that the artificial intelligence model is not available at the current position and take action to immediately return to the range where the artificial intelligence model is available for use.

As described above, according to the present embodiment, an artificial intelligence model is available for use only under a condition suitable for a specific location or a specific space. This makes it possible to appropriately manage the artificial intelligence model in an environment suitable for the use.

### Second Embodiment

According to a second embodiment, a system will be described in which an artificial intelligence model is shared between user terminals including the above-described information processing apparatus, and positions of the user terminals are measured to manage the artificial intelligence model that is suitable for specific spatial information. Different points from the first embodiment will be described below.

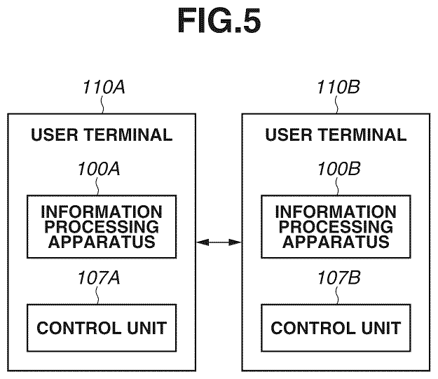

FIG. 5 illustrates an example of a system configuration for managing an artificial intelligence model shared between user terminals including the information processing apparatus according to the present embodiment. A user terminal 110A has a configuration including an information processing apparatus 100A and a control unit 107A that controls the artificial intelligence. The information processing apparatus 100A and the control unit 107A have functions similar to those of the information processing apparatus 100 and the control unit 107 illustrated in FIG. 2, respectively. Similarly, a user terminal 110B also includes an information processing apparatus 100B and a control unit 107B that have functions similar to those of the information processing apparatus 100 and the control unit 107 illustrated in FIG. 2, respectively.

First, an example will be described of a system for providing an artificial intelligence model stored by the user terminal 110A to the user terminal 110B and managing the artificial intelligence model in a specific range. According to the present embodiment, the setting unit 101 of the user terminal 110A sets, for example, a threshold value L_{TH} (m) for a distance between the user terminals as spatial information regarding where the artificial intelligence model is available for use. In this case, it is not necessary to specify a specific position of a facility using a map application or the like as described in the first embodiment. Based on a current distance L_{AB} (m) between the user terminals, the artificial intelligence model provided by the user terminal 110A is then made available for use in the user terminal 110B.

For example, a usage condition that the artificial intelligence model is available for use can be set in a case where the current distance L_{AB} between the user terminals is less than the threshold value L_{TH}.

According to the present embodiment, the measurement unit 103 of the user terminal 110A measures the distance between the user terminals using, for example, a Wi-Fi® device or the like built in the user terminal 110A. As a method for measuring the distance, for example, a known technique is used, such as measuring a distance based on the magnitude of a radio wave intensity or measuring a distance based on the round-trip time and the propagation speed of a radio wave between the user terminals. Alternatively, coordinates of each user terminal may be acquired using the GPS built in the user terminal to calculate the distance from each coordinate.

The provision unit 102 and the restriction unit 104 of the user terminal 110A perform processing similar to that of the first embodiment. As described above, the user terminal 110A can provide an artificial intelligence model and manage the artificial intelligence model on the user terminal 110B to which the model is provided.

In the system that manages the artificial intelligence model according to the present embodiment, it is also conceivable that the user terminal 110A, which provides the artificial intelligence model, may temporarily move away from the user terminal 110B or that the communication may become temporarily unstable. Thus, the setting unit 101 may be able to set a certain grace period as the usage condition in a case where the current position of the user terminal 110B is outside the available range or a case where the position information cannot be acquired due to unstable communication. In this case, the restriction unit 104 suspends the use of the artificial intelligence model only in a case where the spatial information does not satisfy the usage condition and that state continues for a certain period of time, so that the user terminal 110B can continue using the artificial intelligence model.

### Modification

As a modification of the present embodiment, an example will now be described of a system for providing the artificial intelligence model stored by the user terminal 110A to the other two user terminals to manage the artificial intelligence model in a specific range.

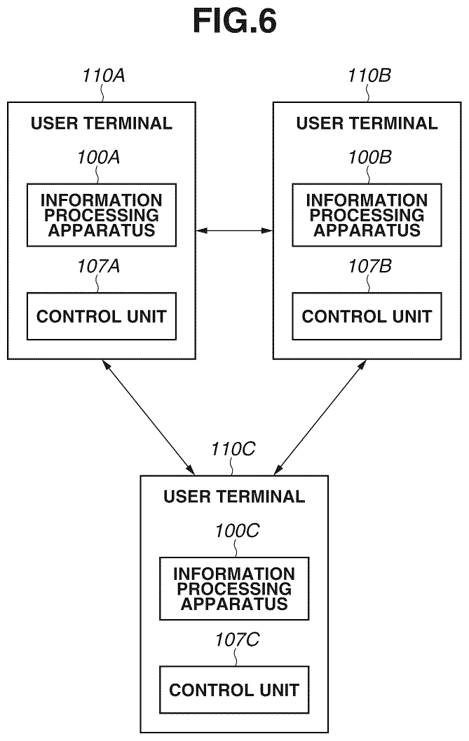

FIG. 6 is a diagram illustrating an example of a system configuration for managing an artificial intelligence model shared between user terminals including the information processing apparatus according to the modification of the present embodiment. A user terminal 110C includes an information processing apparatus 100C and a control unit 107C that have functions similar to those of the information processing apparatus 100 and the control unit 107 illustrated in FIG. 2, respectively. An example will now be described of a system for providing an artificial intelligence model stored by the user terminal 110A to the user terminals 110B and 110C to manage the artificial intelligence model in a specific range.

The measurement unit 103 of the user terminal 110A measures the distance L_{AB} between the user terminals 110A and 110B, a distance L_{AC} between the user terminals 110A and 110C, and a distance L_{BC} between the user terminals 110B and 110C. In the system with the configuration as described above, the setting unit 101 of the user terminal 110A sets the threshold value L_{TH} for the distance between the adjacent user terminals as the usage condition for the spatial information regarding where the artificial intelligence is available for use.

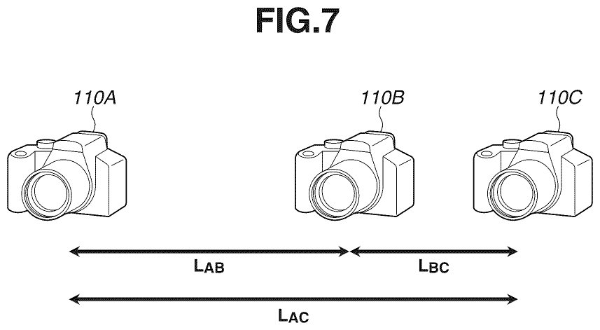

For example, it is assumed that the user terminals 110A, 110B, and 110C have a positional relationship as illustrated in FIG. 7. It is also assumed that the distance L_{AC} between the user terminal 110A, which provides the artificial intelligence model, and the user terminal 110C, which receives the provision, is greater than or equal to the threshold value L_{TH}. In this case, if the distance L_{AB} between the user terminals 110A and 110B is less than the threshold value L_{TH}, and the distance L_{BC} between the user terminals 110B and 110C is less than the threshold value L_{TH}, it is determined that the user terminal 110C also satisfies the condition for using the artificial intelligence model. In a case where the distance L_{AB} between the user terminals 110A and 110B is greater than or equal to the threshold value L_{TH}, it is determined that the user terminal 110B does not satisfy the condition for using the artificial intelligence model provided by the user terminal 110A. Thus, in this case, even if the distance L_{BC} between the user terminals 110B and 110C is less than the threshold value L_{TH}, it is determined that the user terminal 110C does not satisfy the usage condition for the artificial intelligence model. Even if a user terminal is positioned at a certain distance away from the user terminal that provides the artificial intelligence model, this configuration enables the artificial intelligence model only suitable for a specific space within a user group that intends to use the artificial intelligence model to be managed.

As described above, according to the present embodiment, an artificial intelligence model can be used only within a certain distance from a user terminal that provides the artificial intelligence model or a group. In this manner, the artificial intelligence model can be used only under a condition suitable for a specific location or a specific space, so that the artificial intelligence model can be more appropriately managed.

### Third Embodiment

According to the present embodiment, an example will be described of a system that provides an artificial intelligence model available for use in a specific spatial range, shares input and output data on the artificial intelligence model, and further trains the artificial intelligence model. Different points from the first embodiment will be described below.

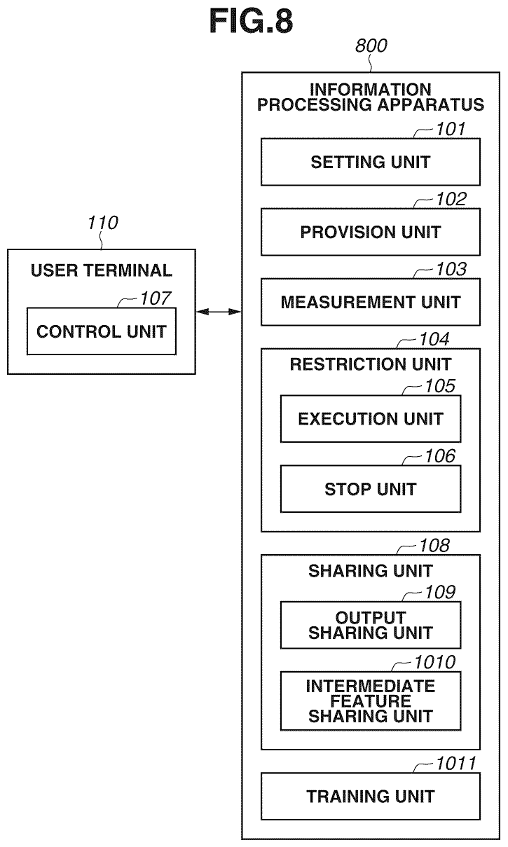

FIG. 8 is a block diagram illustrating an example of a functional configuration of an information processing apparatus 800 according to the present embodiment.

As illustrated in FIG. 8, the information processing apparatus 800 includes a sharing unit 108 and a training unit 1011 in addition to the configuration according to the first embodiment illustrated in FIG. 2.

The sharing unit 108 includes an output sharing unit 109 and an intermediate feature sharing unit 1010. The output sharing unit 109 performs processing to share an output image captured by the user terminal 110 using the artificial intelligence model with the information processing apparatus 800. For example, when the user terminal 110 permits sharing, the output sharing unit 109 inputs the output image captured by the user terminal 110 to the information processing apparatus 800. The output image shared by the output sharing unit 109 is used to train the artificial intelligence model in the training unit 1011 described below. When the user terminal 110 becomes unable to use the artificial intelligence model, the output sharing unit 109 stops sharing the output image. When the sharing is stopped, the information processing apparatus 800 deletes the output image input from the user terminal 110. The intermediate feature sharing unit 1010 will be described below.

The training unit 1011 uses the output image input from the user terminal 110 to train the artificial intelligence model.

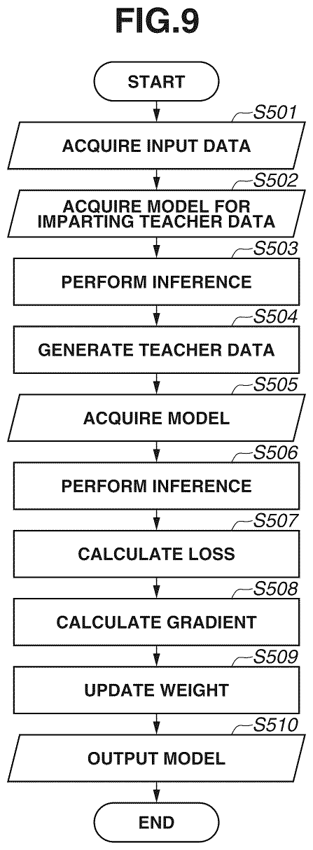

FIG. 9 is a flowchart illustrating an example of a specific processing procedure through which the training unit 1011 trains the artificial intelligence model according to the present embodiment.

In step S501, the training unit 1011 acquires input data to be used for training. The input data used for training includes an image data group of the output image shared by the output sharing unit 109. The input data used for training may include an image data group stored in the information processing apparatus 800 in advance.

In step S502, the training unit 1011 acquires a trained artificial intelligence model for assigning teacher data. The trained artificial intelligence model may be the artificial intelligence model provided to the user terminal 110 or a different artificial intelligence model. Generally, an artificial intelligence model to be provided to an edge terminal, such as the user terminal 110, has a small number of parameters due to hardware constraints. Thus, by acquiring an artificial intelligence model having more parameters, more accurate teacher data can be generated.

In step S503, the training unit 1011 performs inference processing on the image data group acquired in step S501 using the artificial intelligence model acquired in step S502. In the inference processing, for example, the face area of a subject to be imaged is detected.

In step S504, the training unit 1011 generates teacher data. For example, from among pairs of the image data acquired in step S501 and the inference result acquired by the inference processing in step S503, a pair with high inference reliability is adopted as teacher data.

In step S505, the training unit 1011 acquires an artificial intelligence model to be trained.

In step S506, the training unit 1011 performs inference processing on image data acquired from the teacher data generated in step S504 using the artificial intelligence model acquired in step S505.

In step S507, the training unit 1011 calculates a value of a loss function from the inference result acquired by the inference processing in step S506 and the inference result acquired from the teacher data generated in step S504. As the loss function, a cross-entropy function or a squared error function may be used for, for example, a face area of a subject to be imaged.

In step S508, using the loss function value calculated in step S507, the training unit 1011 calculates the gradient for updating the weight by a backpropagation method.

In step S509, the training unit 1011 updates the parameter (the weight) of the artificial intelligence model acquired in step S505 using the gradient calculated in step S508. In step S510, the updated artificial intelligence model is output.

The processing for updating the parameter of the artificial intelligence model as described above is repeated until the value of the loss function converges to train the artificial intelligence model.

The artificial intelligence model is trained using images acquired by actual image capturing using the above-described procedure, which makes it possible to provide an artificial intelligence model more suitable for a specific space and a specific time period to a user terminal. Similar to the first or second embodiment, a condition for availability can be individually set to the trained artificial intelligence model by the setting unit 101.

The intermediate feature sharing unit 1010 will now be described. The intermediate feature sharing unit 1010 performs processing to share intermediate features calculated when the user terminal 110 executes the artificial intelligence model with the information processing apparatus 800. The intermediate feature sharing unit 1010 also performs processing to share intermediate features stored in advance in the information processing apparatus 800 with the user terminal 110. The intermediate feature sharing unit 1010 also performs processing for providing intermediate features shared with another user terminal to the user terminal 110.

An intermediate feature refers to the output of intermediate layers in a case where the artificial intelligence model is configured with a multi-layered neural network and a recognition task that uses intermediate features exists. Examples of the recognition task that uses intermediate features include a tracking task for tracking a specific subject in a time series manner. In the tracking task, the artificial intelligence model stores intermediate features as a template, and a subject can be tracked by correlation matching being performed between the template and the features of a current frame. In such a tracking method, it is known that when the posture of a subject significantly changes, a pattern from the template changes, which results in decrease in reliability of correlation matching, and an increase in the likelihood of tracking loss.

The information processing apparatus 800 stores intermediate features of a tracking target subject captured in various postures and angles. The intermediate feature sharing unit 1010 shares these intermediate features with the user terminal 110, so that the user terminal 110 can perform more stable subject tracking. Sharing the intermediate features acquired by the user terminal 110 with the information processing apparatus 800 and other user terminals enables the other user terminals to also perform stable tracking.

Intermediate features can be used for a task for tracking a specific subject or face recognition, and thus, personal information may leak out in a case where the subject is a person. Thus, the intermediate feature sharing unit 1010 manages an available range based on spatial information in the same manner as that of the artificial intelligence model. Thus, if the user terminal moves outside the available range, the intermediate feature sharing unit 1010 stops sharing the intermediate features with the user terminal. In this manner, by setting the intermediate features unavailable in the user terminal outside of the available range, leakage of personal information about a specific subject can be prevented.

As described above, according to the present embodiment, the information processing apparatus 800 and the user terminal 110 can share output data and intermediate features in using an artificial intelligence model. This makes it possible to enhance performance of the artificial intelligence model suitable for a specific location or a specific space to manage the artificial intelligence model including the output of the artificial intelligence model and the intermediate features more appropriately.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-212469, filed Dec. 5, 2024, which is hereby incorporated by reference herein in its entirety.

What is claimed is:

1. An information processing apparatus comprising:
a setting unit configured to set a usage condition including spatial information about a position range of a user terminal that performs processing using artificial intelligence;
a provision unit configured to provide a model of the artificial intelligence to the user terminal;
an acquisition unit configured to acquire position information about the user terminal to which the artificial intelligence model is provided; and
a restriction unit configured to restrict use of the artificial intelligence model provided to the user terminal based on the usage condition set by the setting unit and the position information about the user terminal acquired by the acquisition unit.

2. The information processing apparatus according to claim 1, wherein, in a case where the position information about the user terminal satisfies the usage condition, the restriction unit sets the artificial intelligence model as available for use in the user terminal, and in a case where the position information about the user terminal does not satisfy the usage condition, the restriction unit sets the artificial intelligence model as unavailable for use in the user terminal.

3. The information processing apparatus according to claim 2, wherein the restriction unit encrypts the artificial intelligence model in the user terminal to set the artificial intelligence model unavailable for use and decrypt the artificial intelligence model encrypted in the user terminal to set the artificial intelligence model available for use.

4. The information processing apparatus according to claim 3,
wherein the provision unit provides the artificial intelligence model in an encrypted state to the user terminal, and
wherein, in a case where the position information about the user terminal satisfies the usage condition, the restriction unit transmits data for decrypting the encrypted artificial intelligence model to the user terminal to set the artificial intelligence model available for use in the user terminal.

5. The information processing apparatus according to claim 1,
wherein the provision unit provides a part of a parameter group included in the artificial intelligence model to the user terminal, and
wherein, in a case where the position information about the user terminal satisfies the usage condition, the restriction unit provides a remainder of the parameter group included in the artificial intelligence model to the user terminal to set the artificial intelligence model available for use in the user terminal.

6. The information processing apparatus according to claim 1,
wherein the acquisition unit acquires the position information about the user terminal at a predetermined time interval, and
wherein the restriction unit switches between a state where the artificial intelligence model is available for use and a state where the artificial intelligence model is unavailable for use based on the position information about the user terminal acquired at the predetermined time interval.

7. The information processing apparatus according to claim 1,
wherein the spatial information includes coordinates representing a range where the artificial intelligence model is available for use, and
wherein, in a case where coordinates in the position information about the user terminal are not within the range where the artificial intelligence model is available for use, the restriction unit sets the artificial intelligence model provided to the user terminal as unavailable for use.

8. The information processing apparatus according to claim 1, wherein, in a case where the position information about the user terminal does not satisfy the usage condition, the restriction unit notifies the user terminal that the artificial intelligence model is unavailable for use.

9. The information processing apparatus according to claim 1,
wherein the spatial information includes a threshold value for a distance from the user terminal to the information processing apparatus or to a terminal that enables use of the artificial intelligence model, and
wherein, in a case where the position information about the user terminal is within a range defined by the threshold value, the restriction unit sets the artificial intelligence model as available for use in the user terminal, and in a case where the position information about the user terminal is outside the range defined by the threshold value, the restriction unit sets the artificial intelligence model as unavailable for use in the user terminal.

10. The information processing apparatus according to claim 1, wherein, in a case where a state where the position information about the user terminal does not satisfy the usage condition continues for a predetermined period of time or more, the restriction unit sets the artificial intelligence model as unavailable for use in the user terminal.

11. The information processing apparatus according to claim 1, further comprising a sharing unit configured to share with the user terminal an intermediate feature generated by processing using the artificial intelligence in a case where the position information about the user terminal satisfies the usage condition, wherein, in a case where the position information about the user terminal does not satisfy the usage condition, the sharing unit stops sharing the intermediate feature.

12. The information processing apparatus according to claim 1, further comprising:
a sharing unit configured to acquire and share output data acquired using the artificial intelligence model in the user terminal; and
a training unit configured to train the artificial intelligence model using the output data shared by the sharing unit.

13. The information processing apparatus according to claim 12, wherein, in a case where the position information about the user terminal does not satisfy the usage condition, the sharing unit stops sharing the output data.

14. A method for controlling an information processing apparatus, the method comprising:
setting a usage condition including spatial information about a position range of a user terminal that performs processing using artificial intelligence;
providing a model of the artificial intelligence to the user terminal;
acquiring position information about the user terminal to which the artificial intelligence model is provided; and
restricting use of the artificial intelligence model provided to the user terminal based on the set usage condition and the acquired position information about the user terminal.

15. A non-transitory computer readable storage medium storing a program for causing a computer to execute:
setting a usage condition including spatial information about a position range of a user terminal that performs processing using artificial intelligence;
providing a model of the artificial intelligence to the user terminal;
acquiring position information about the user terminal to which the artificial intelligence model is provided; and
restricting use of the artificial intelligence model provided to the user terminal based on the set usage condition and the acquired position information about the user terminal.
